(19) United States
(12) Patent Application Publication
(10) Pub. No.: US 2004/0248653 A1
(43) Pub. Date: Dec. 9, 2004

(54) System and method for providing user interactive experiences according to user's physical location

(76) Inventors: Mark Barros, Wellington, FL (US); James Hymel, Lake Worth, FL (US); Minh Pham, Boyton Beach, FL (US)

Correspondence Address: ARNALL GOLDEN GREGORY LLP, 1201 West Peachtree Street, Atlanta, GA, 30309, US

(21) Appl. No.: 10/455,646

(22) Filed: Jun. 5, 2003

(51) Int. Cl. A63F 13/00

(52) U.S. Cl. 463/43

(57) ABSTRACT

A system and method for enabling special features of an electronic game played on a mobile device 202. The mobile device 202 receives GPS information to determine its location and transmits the location information to a server 116. The server 116 uses the location information to alter the electronic game on the mobile device 202.

### BACKGROUND OF THE INVENTION

1. Field of the Invention

The present invention generally relates to providing interactive experiences to user of a mobile device . More specifically, the present invention relates to a method for physical surroundings to modify a user's interactive experience when playing an electronic game on a mobile device.

2. Description of the Related Art

Wireless communications have become accessible to everyone. The types of devices used for wireless communications also have increased substantially. The variety of wireless telecommunication devices now includes cellular telephones, personal digital assistants (PDAs), pagers, two-way email devices, etc. Most of these devices are not only used for voice communications, but also used to provide entertainment to users.

FIG. 1 depicts a prior art cellular telecommunication network 100 that supports not only voice communications but also data communications such as interactive games. The communication network 100 includes one or more communication towers 106, each connected to a base station (BS) 110 and serving users with communication devices 102. The communication devices 106 can be cellular telephones, pagers, personal digital assistants (PDAs), laptop computers, or other hand-held, stationary, or portable communication devices that use a wireless and cellular telecommunication network. The commands and data input by each user are transmitted as digital data to a communication tower 106. The communication between a user using a communication device 102 and the communication tower 106 can be based on different technologies, such code division multiplexed access (CDMA), time division multiplexed access (TDMA), frequency division multiplexed access (FDMA), the global system for mobile communications (GSM), or other protocols that may be used in a wireless communications network or a data communications network. The data from each user is sent from the communication tower 106 to a base station (BS) 110, and forwarded to a mobile switching center (MSC) 114, which can be connected to a public switched telephone network (PSTN) 118 and the Internet 120. The wireless subscribers can be identified by mobile identification number (MIN) or the wireless device's electronic identification number (EIN).

The MSC 114 may be connected to a server 116 that supports different applications available to subscribers using the wireless communications devices 102. The server 116 may also be connected to the Internet 120 and operated by a third party. The server 116 hosts many different games that can be accessed by users at desktop computers 122 or mobile devices 102.

Generally, the games, or the characteristics of the players at the games, do not change depending on the physical location of the players because the players generally are not mobile. Traditionally, the players are at their computer terminals 122 and do not change their location during the game. Even when a player moves his physical position, if he is using his mobile device to play the game, the game is not impacted by the changes in player's physical location.

Many electronic games provided by the wireless devices are interactive multi-user games, i.e., games that are simultaneously played by several different players. An interactive multi-user game takes input from all participants and sends different screen updates to each participant. The game can also assign different properties to different players. For example, the screen displayed for player A may be different from the screen display for player B, and player A may have different attributes from player B.

Most of the games are ported directly from a distributed computing environment, where individual computing devices are interconnected through the Internet to a server. The games are generally hosted by the server and distributed to the participants. The games and the players follow a set of predefined rules. The features or characteristics of a player during a game may change depending on the player's ability but generally not affected by the physical environment of the player.

Another aspect of the development in wireless telecommunications has enabled new advertising venues. It is not uncommon for a user to receive an email advertisement on his wireless communications device. Generally, users consider these unsolicited emails as annoyance and discard them without reading. Consequently, advertisers cannot achieve their objective of attracting clients to their stores.

### SUMMARY OF THE INVENTION

The present invention provides a way to attract users to a store by enhancing their interactive experience while executing applications on their wireless devices. The method enables special features in an application executed on a wireless device when the wireless device is within a predefined vicinity of a store. The method employs a server, which hosts applications and interacts with the wireless device through a wireless communications network. The server receives an application enabling request, sends an enabling signal to the wireless device, receives a device location from the wireless device, compares the device location with at least one predefined location, and if the device location is within a predefined range of the at least one predefined location, sends a feature enabling signal to the wireless device.

The method also allows a wireless device that is in communication with the server through the wireless communications network to interact with a user through an application. To execute the application the wireless device sends an activation request for the application to the server, sends device identification to the server, sends location information to the server, receives application information from the server, receives a player feature from the server, wherein the player feature is dependent on the location information, and modifies a user feature according to the player feature.

The invention also is a system for enabling special features in an application on a wireless device when the wireless device is within a predefined vicinity. The system includes a wireless device in communication with a wireless communications network and a plurality of satellites. The wireless device receives position information from the plurality of satellites and calculates a location information based on the position information received. The wireless device is also capable of displaying an electronic game that changes its behavior according to a signal from a remote server. The server, which is in communication with the wireless communications network, stores user information and a list of predefined locations. The server uses the location information received from the user and the list of predefined locations to alter the electronic game on the wireless device.

Other features of the present invention will become apparent after review of the hereinafter set forth Brief Description of the Drawings, Detailed Description of the Invention, and the Claims.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 illustrates a prior art communications network. FIG. 2 illustrates a network.

FIG. 3 illustrates architecture of a mobile device.

FIG. 4 is a flow chart for a mobile device.

FIG. 5 is a flow chart for a server.

FIG. 6 is a flow chart for a mobile device that does not interface with a communications network.

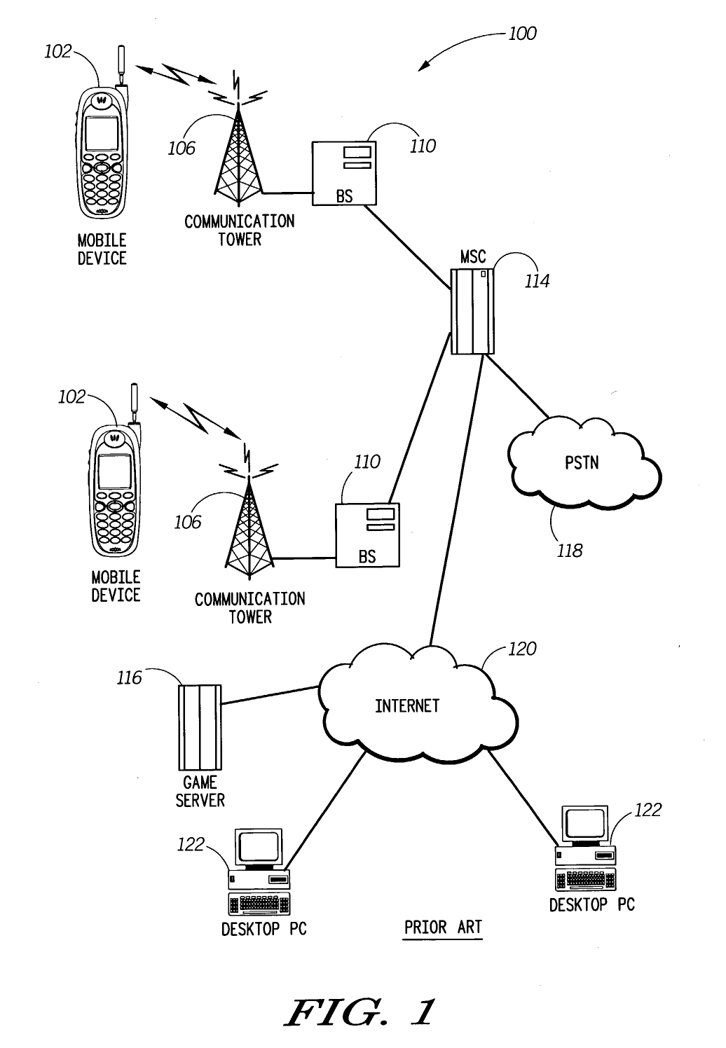

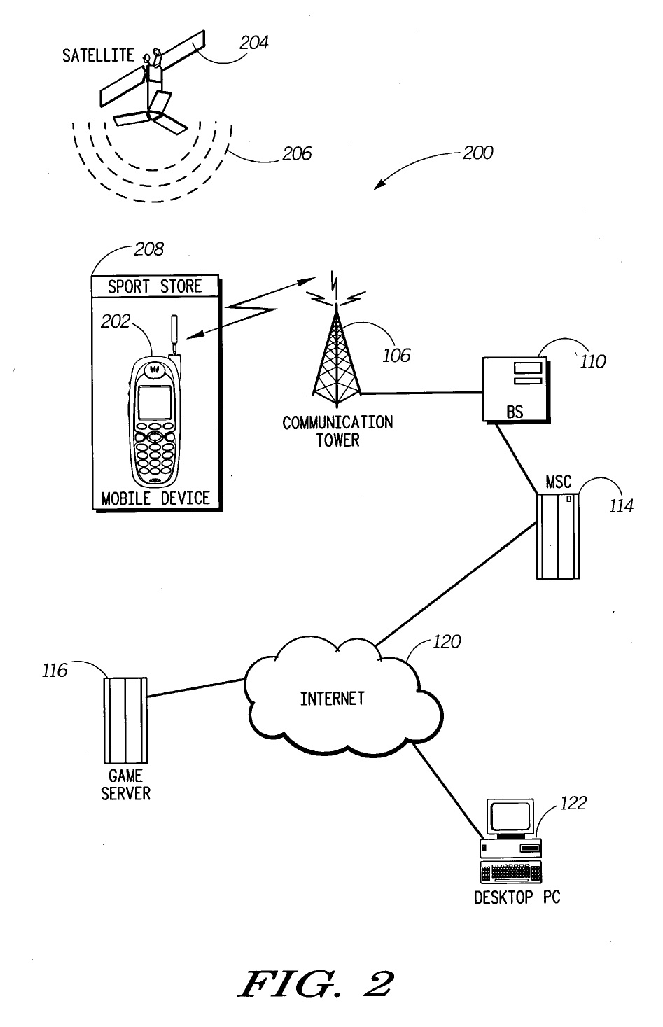

### DETAILED DESCRIPTION OF THE INVENTION

As required, detailed embodiments of the present invention are disclosed herein;

however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In this description, the terms “communication device,” “wireless device,” “wireless telephone,” “wireless communications device,” “mobile device,” “mobile terminal,” and “wireless handset” are used interchangeably, and the term “game” as used herein is intended to encompass executable and nonexecutable software files, raw data, aggregated data, patches, and other code segments. Further, like numerals refer to like elements throughout the several views.

With advent of 3^{rd} generation (3G) wireless communication technology, more bandwidth has become available for wireless communications, and wireless telecommunication devices, such as cellular telephones, pagers, personal digital assistants (PDAs) have increasing wireless capabilities. The wireless devices are increasingly being used not only for voice communications but also for entertainment. Now it is common for users to play electronic games on their handsets.

The invention is an apparatus and method for improving the user interactive experience by allowing a user's physical location to affect the game that the user is playing. By being at a particular location, the user's strength in the game may increase significantly, or the game's scenario may change to offer more rewards. The invention also discloses a method to increase revenues for game developers by providing a venue for the game developers to get advertising revenues from merchants who want to make their stores part of the gaming experience for the users. For example, the game developer incorporates the coordinates of a merchant's store into the game, and the game also allows input of the user's physical location. When the user playing the game enters the store, the game awards extra strength to the user. The game learns about the user's physical location through the Global Positioning System (GPS) information received by the user's mobile device.

FIG. 2 depicts a network architecture 200 that supports the invention. A server 116 is in communication with the Internet 120 and serves both users using a desktop computer 122 and a mobile device 202. The user at the desktop computer 122 accesses directly the server 116 via the Internet 120. The user at the mobile device 202 accesses the server 116 via a wireless communication network, i.e., the mobile device 202 sends and receives data from a communication tower 106 connected to a base station 110. The base station 110 is connected to a mobile switching center 114, which is in communication with the Internet 120. The mobile device 202 also receives position information from a plurality of satellites 204 of the Global Positioning System (GPS). If the mobile device 202 is inside a store 208 when the user is playing a game, the server 116 compares the mobile device's 202 physical location with the store's 208 coordinates. If the server 116 detects the mobile device 202 is within a predefined vicinity of the store 208, the server 116 sends a special feature enabling signal via the wireless network to the mobile device 202, and the user's game is modified accordingly.

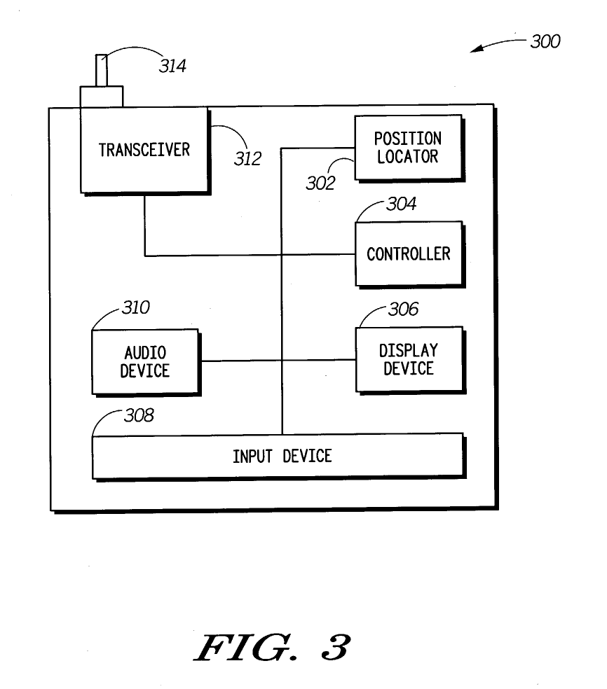

The user's mobile device 202 has the capability to receive position information from the GPS satellites. FIG. 3 illustrates an architecture 300 for the mobile device 202. The mobile device 202 has a transceiver 312 connected to an antenna 314 for communication with the BS 106. The mobile device 202 also has a position locator 302 for receiving GPS information and calculating the current location information. The mobile device 202 is equipped with a display device 306, an audio device 310, and an input device 308 for interfacing with the user. A controller 304 generally controls the operation of the mobile device 202. The input device may includes, besides a keyboard, a device interface for interfacing with disk drives and a network interface for interfacing with a land-based network.

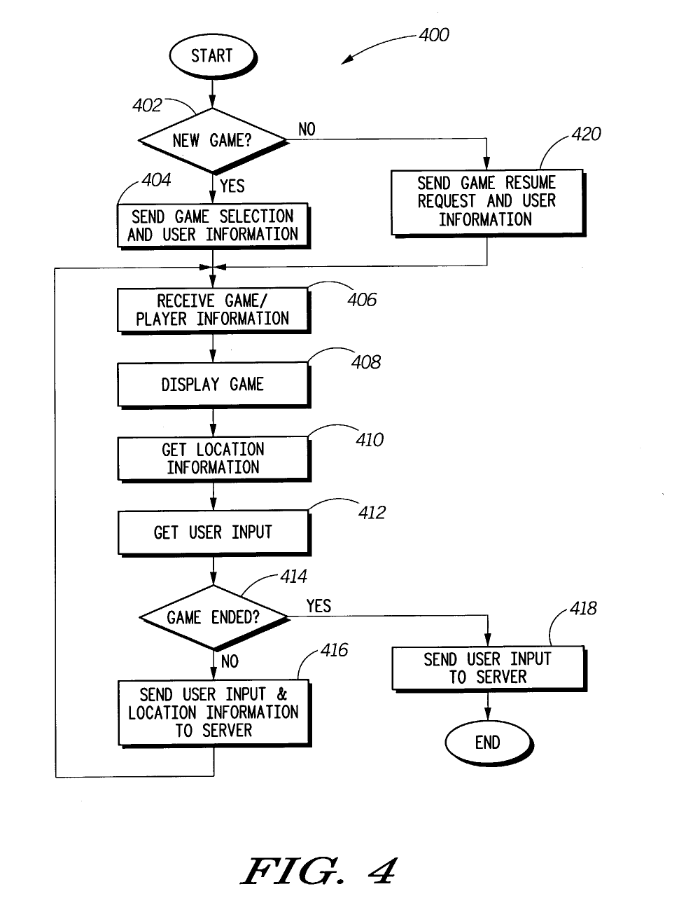

FIG. 4 is a flow chart 400 for a mobile device. After powering up the mobile device 202, a user has the option of starting a new game or resuming an interrupted game on the mobile device 202, step 402, and the mobile device will send either the new game selection, step 404, or a game resumption request, step 420, to a server 116. The mobile device 202 receives game and user information from the server 116, step 406. The game information may be a game applet that runs on the mobile device 202, and the user information may be the information from the user's last game, if the game is of an accumulative type and was interrupted. For certain games, the user may interrupt the game at any time and the information is saved on the server 116 for later retrieval.

The mobile device 202 displays the game, step 108, and gets the location information from signals from the GPS satellites, step 410. The mobile device 202 receives user input to the game, step 412, and verifies whether the user input is a command for the game or a game ending input, step 414. If the user input is to end the game, the mobile device 202 sends the user input to the server 116, step 418, and the game ends. If the user input is a command for the game, the mobile device 202 sends the user input and the location information to the server, step 416, and the mobile device 202 repeats steps 406-416.

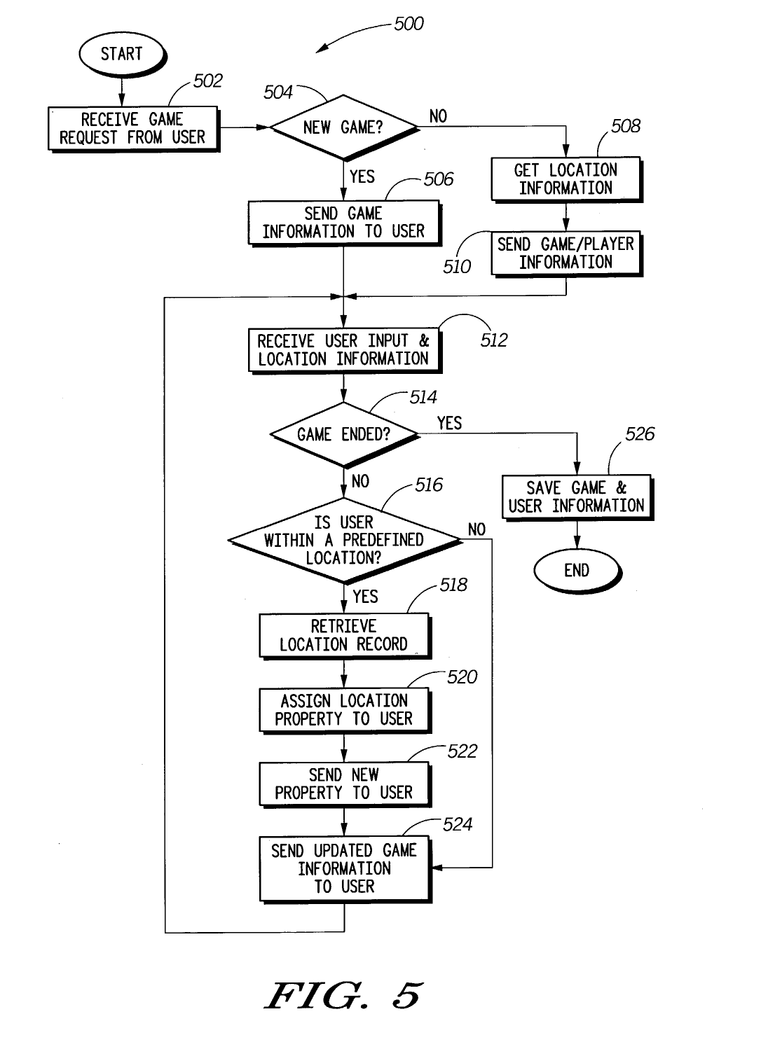

FIG. 5 is a flow chart 500 for the server 116. The server 116 stores games and user information and interfaces with the mobile device 202. The user can select a new game from a menu provided by the server or resume an interrupted game. After receiving the game request from the user, step 502, the server checks whether it is for staring a new game or resuming an interrupted game, step 504. If the user wants to resume an interrupted game, the server 116 retrieves the interrupted game information and related player information, step 508 and sends the game information and the player information at the point when the game was interrupted to the mobile device 202, step 510. If the user chooses to start a new game, the server 116 sends the game information to the user, step 506. After sending the game and user information to the mobile device 202, the server 116 monitors the user's game. The server receives the user input and the location information, step 512, from the mobile device 202 and checks whether the user is ending the game, step 514. If the user chooses to end the game, an option may be provided to the user to save the game information, and the server 116 will save the game and user information for later retrieval, step 526.

If the user input is not a game ending command, the server 116 checks the user location information to see if the user is within a predefined location, step 516. A game may have many predefined locations and each predefined location may change the characteristics of each game differently. If the user and his mobile device 202 is within the vicinity of a predefined location, the server 116 retrieves a location record for that location, step 518. The location record contains features and properties that can be assigned to the user, step 520, when the user is at that particular location. The location features may include assigning special characteristics unique to that location to the user, and the location features change the user's properties. After changing the user property, the server 116 sends the new user property to the user, step 522, and also sends the updated game information to the user, step 524. The server 116 then repeats step 512-524.

The following is a use scenario for the invention. When developing a new game, a developer may sell advertising slots in the game to merchants who want to attract consumers to their stores. A merchant pays the developer to include his store as part of the game. The game developer incorporates the store's geographical coordinates into the game. The geographical coordinates preferably are in the same format as used in the GPS system and saved in a location database. After the store is integrated into the game, the store will affect the game's or user's characteristics. For example, in a dragon slaying game, the user may increase his character's physical strength in the game by the mere fact of being physically inside the store when playing the game. In another example, in the same dragon slaying game, a better sword may be available to the user's character when he steps into the store. The store may advertise these special game features and thus attract more people to the store.

After the game is developed and placed on a server, the user may select the game for playing. The server may require the user to have a subscription for playing the game. The server provides a menu of available games to the mobile device and the user can select a game to play. After selecting the game, the selection and the user information is sent to the server, and the server may validate user information against a subscriber database before sending the game to the mobile device. The subscriber database may include user identification information and a password. The user identification information may also be the mobile device's electronic identification number (EIN) or mobile identification number (MIN).

After verifying that the user is a subscriber, the server sends the game to the mobile device and enters into a monitoring mode. In the monitoring mode, the server receives user inputs, generates updated game information, and sends the update game information to the mobile device.

The mobile device receives the game and displays it on a display screen. The mobile device also receives signals from the GPS system and calculates its own location information. The mobile device constantly sends user input and the location information to the server and receives the game information from the server until the user ends the game.

When playing a game, the user notices a sport equipment store, for example, that provides special features to the game, and the user enters the sport equipment store. After entering the sport equipment store, the mobile device sends its new location information to the server. The server receives the new location information and checks it against the location database. When the server detects the mobile device is within a predefined location, i.e., the sport equipment store, the server retrieves a location record for the sport equipment store and enables special features listed for the sport equipment store on the mobile device. If the user leaves the sport equipment store when playing the game, the mobile device sends its new location information to the server, and the server takes away the special feature previously enabled for the mobile device.

If the user interrupts the game, a game ending signal is sent to the server, and the server stores the current user and game information. When the user resumes the game, a game resumption request is sent to the server. After receiving the game resumption request, the server retrieves the user and game information, updates them according to the user's current location information, and sends the user and game information to the mobile device.

In an alternative embodiment, the predefined location information may be embedded in the game that is downloaded to the wireless device. The wireless device, after receiving signals from the GPS satellites, calculates its own position and compares the position with the predefined locations embedded in the game. If the location matches one of the predefined locations, the game enables special a corresponding special feature for that location and sends the enabled special feature information to the server. The server receives the enabled special feature information and sends updates to other players in the game.

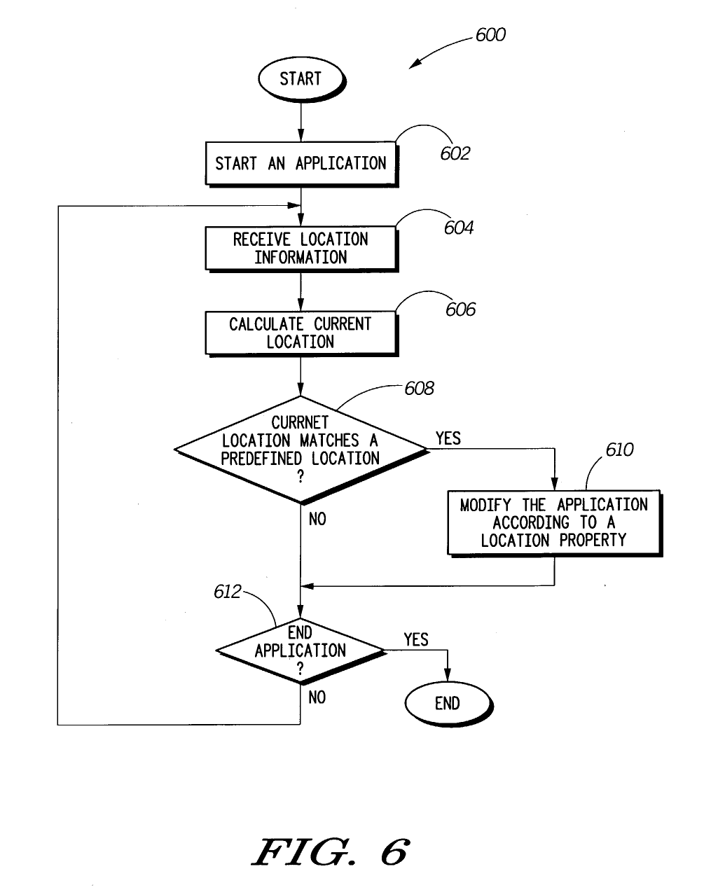

In yet another alternative embodiment, the invention is a self contained apparatus that provides enhanced user interactive experience while the user is using a specific application as illustrated in FIG. 6. The user interface provided by the application changes according to the user's physical location. A list of predefined location information is embedded in the application that is downloaded to the mobile device. The user starts the application, step 602, and the apparatus receives location information, step 604, from outside sources such as GPS satellites or communications towers in a communications network. The mobile device, after receiving signals from the GPS satellites, calculates its current position, step 606, and compares the position with the predefined locations embedded in the application, step 608. If the location matches one of the predefined locations, the application modifies the application or enables special a corresponding special feature for that location, step 610. While the user has not ended the application, step 612, the apparatus repeats the steps of 604-610. For example, if the user is visiting a science museum that provides this enhanced user interface experience, and he sees some previously unknown technical words. The user can request a dictionary application for his mobile device from an application server.

When requesting this dictionary application, the mobile device provides the user's location information to the server. The server receives the request and the location information, matches the location information to the science museum, retrieves the dictionary application with a special feature provided by the science museum, and sends the dictionary application with the special feature to the mobile device.

After receiving the dictionary application with the special feature, the user can look up special words, including technical acronyms, that are not included in a regular dictionary.

In yet another alternative embodiment, the present invention is a self contained apparatus that receives an application through means other than wirelessly from an application server. The application is loaded via a data interface or a network interface and provides enhanced user interactive experience while the user is using the application. The application is equipped with a list of predefined locations that are used to compare with the apparatus' physical location. In this embodiment, the apparatus does not interface with any wireless network. An example of this embodiment is a compact disk based personal navigation application that runs on a personal navigation apparatus. The personal navigation application receives a map information from a compact disk provided by a third party vendor, and the map information includes a list of predefined locations. The compact disk with the map information is loaded into a disk drive connected to the personal navigation apparatus, and the map information is transferred to the personal navigation apparatus. The personal navigation apparatus also receives radio signals from either GPS satellites or other positioning systems. While using this navigation apparatus, if the user approaches an electronic store, a special coupon from the electronic store shows up on the display screen of the navigation device and invites the user to stop by.

Although, the invention is described in terms of receiving signals from the GPS satellites, radio signals transmitted from other suitable navigation and positioning systems may be used as well. One example of the positioning system is Enhanced Observed Time Difference (E-OTD), which is a positioning system based on a wireless network. An E-OTD based device receives signals from neighboring communication towers, records the arrival time of these signals, and calculates its position using a triangulation technique.

Furthermore, though, the invention has been extensively described in terms of playing games on a mobile device, the invention is equally applicable to other applications executed on the mobile device.

In view of the method being executable on a server or a mobile device, the present invention includes programs resident in a computer readable medium, where the programs direct a server or other computer device having a computer platform to perform the steps of the method. The computer readable medium can be the memory of the server, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In the context of the invention, the method may be implemented, for example, by operating portions of the wireless network to execute a sequence of machine-readable instructions, such as wireless communications device or the server. The instructions can reside in various types of signal-bearing or data storage primary, secondary, or tertiary media. The media may comprise, for example, RAM (not shown) accessible by, or residing within, the components of the wireless network. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail maybe made without departing from the spirit and scope of the present invention as set for the in the following claims. Furthermore, although elements of the invention may be described or claimed in the singular, the plural is contemplated unless limitation to the singular is explicitly stated.

What is claimed is:

1. A method for an application server to enable special features in an application executed on a mobile device when a user uses the mobile device within a predefined location, the mobile device being in communication with a wireless communications network, comprising the steps of:
receiving an application enabling request from the mobile device;
in response to the application enabling request, sending an application enabling signal to the mobile device, the application enabling signal capable of enabling an application to be executed on the mobile device;
receiving a device location from the mobile device;
after receiving the device location, comparing the device location with at least one predefined location stored in the application server; and
if the device location is within a predefined range of the at least one predefined location, sending a feature enabling signal to the mobile device, the feature enabling signal capable of causing a feature to be enabled in association with the application's execution.

2. The method of claim 1, further comprising the step of retrieving a location record corresponding to the at least one predefined location, the location record listing features that can be assigned to the mobile device.

3. The method of claim 1, further comprising the steps of receiving user information from the mobile device for verifying whether the user is a subscriber.

4. The method of claim 3, further comprising the step of checking the user information received from the mobile device against a subscriber database in the application server.

5. The method of claim 1, further comprising the steps of:
receiving user information and application information from the mobile device; and
storing the user information and the application information, wherein the user information and the application information are used to resume an interrupted application.

6. The method of claim 5, further comprising the step of, after receiving an application resumption request, retrieving a stored user and application information and sending the store user and application information to the mobile device.

7. The method of claim 1, wherein the device location is in a GPS format.

8. The method of claim 1, wherein the device location is in an E-OTD format.

9. The method of claim 1, further comprising the steps of:
generating an updated application information that reflects enabling of the special features; and
sending the updated application information to the mobile device.

10. The method of claim 1, further comprising the steps of:
receiving an application ending request from the mobile device; and
after receiving the application ending request, storing current user information and current application information in the application server.

11. The method of claim 1, wherein the application enabling request comprises an application resuming request.

12. The method of claim 11, further comprising the steps of:
retrieving a stored user information and a stored application information; and
sending the stored user information and stored application information to the mobile device for enabling the mobile device to resume the application.

13. The method of claim 1, wherein the application is an electronic game.

14. A method for enabling special features in an application executed on a mobile device when the mobile device is within a predefined location, the mobile device being in communication with a application server through a wireless communications network, comprising the steps of:
sending an activation request for the application to the application server;
after sending the activation request, sending a location information to the application server;
receiving an application information from the application server in response to the activation request;
executing an application according to the application information received;
receiving a player feature from the application server in response to the activation request, wherein the player feature is dependent on the location information; and
modifying a user feature in the application according to the player feature received.

15. The method of claim 14, further comprising the steps of:
receiving a position information from a plurality of satellites; and
calculating the location information based on the position information received from the plurality of satellites.

16. The method of claim 14, further comprising the steps of:
receiving a position information from a plurality of communications towers; and
calculating the location information based on the position information received from the plurality of communications towers.

17. The method of claim 14, further comprising the steps of:
prompting a user for identification information;
receiving the identification information in response to prompting the user for identification information; and
transmitting the identification information to the application server to identify the user as a subscriber.

18. The method of claim 14, wherein the application is an electronic game.

19. A system for enabling special features in an application executed on a mobile device when the mobile device is within a predefined vicinity, the mobile device being in communication with a application server through a wireless communications network, comprising:
a mobile device in communication with the mobile communications network, the mobile device being capable of calculating a location information and executing the application; and
an application server in communication with the wireless communications network, the application server having user information and at least one predefined location information,
wherein the application server receives the location information and uses the location information to alter the application on the mobile device.

20. The system of claim 19, wherein the mobile device calculates the location information based on information received from a plurality of communications towers in the wireless communications network.

21. The system of claim 19, wherein the mobile device calculates the location information based on information received from a plurality of satellites.

22. The system of claim 19, wherein the application is an electronic game.

23. An apparatus for providing enhanced user interactive experiences while executing an application software, comprising:
a transceiver device connected to an antenna for communicating with a wireless network and for receiving an application from the wireless network;
a position locator for receiving location information from a plurality of radio signal emitters, the position locator being capable of calculating the apparatus' current position based on the location information received; and
a controller for controlling execution of the application on the apparatus, wherein the current position of the apparatus affects the execution of the application on the apparatus.

24. The apparatus of claim 23, wherein the location information is received from a plurality of GPS satellites.

25. The apparatus of claim 23, wherein the location information is received from a plurality of communications towers in the wireless communications network.

26. The apparatus of claim 23, wherein the application is an electronic game.

27. An apparatus for providing enhanced user interactive experiences while executing an application software, comprising:
a position locator for receiving location information from a plurality of radio signal emitters, the position locator being capable of calculating the apparatus' current position based on the location information received;
a data interface for receiving applications from external sources; and
a controller for controlling execution of an application received from the data interface on the apparatus, wherein the current position of the apparatus affects the execution of the application on the apparatus.

28. The apparatus of claim 27, wherein the location information is received from a plurality of GPS satellites.

29. The apparatus of claim 27, wherein the location information is received from a plurality of communications towers in the wireless communications network.

30. The apparatus of claim 27, wherein the application is an electronic game.

31. The apparatus of claim 27, wherein the device interface is a disk drive.

32. The apparatus of claim 27, wherein the device interface is a network interface.

33. A method for enabling special features in an application executed on a mobile device when the mobile device is within a predefined location, comprising the steps of:
executing an application, wherein the application includes a list of predefined locations;
calculating a current location based on location information received from an external source;
comparing the current location against the list of predefined locations; and
if the current location matches a location on the list of predefined locations, modifying a user feature in the application.

34. The method of claim 33, wherein the external source comprises a plurality of satellites.

35. The method of claim 33, wherein the external source comprises a plurality of communications towers.

36. The method of claim 33, wherein the application is an electronic game.

37. The method of claim 33, wherein the application is a personal navigation application.
